(19) United States
(12) Patent Application Publication
(10) Pub. No.: US 2009/0133529 A1
(43) Pub. Date: May 28, 2009

(54) Torsional Vibration Damper

(75) Inventors: Igor Kister, Wuerzburg (DE); Thomas Dogel, Bad Kissingen (DE); Hartmut Bach, Schweinfurt (DE); Frank Eichhorn, Grafenrheinfeld (DE)

Correspondence Address: COHEN, PONTANI, LIEBERMAN & PAVANE LLP, 551 FIFTH AVENUE, SUITE 1210, NEW YORK, NY, 10176, US

(73) Assignee: ZF Friedrichshafen AG, Friedrichshafen (DE)

(21) Appl. No.: 11/992,171

(22) PCT Filed: Nov. 25, 2006
(86) PCT No.: PCT/EP2006/011314

§ 371 Date: Mar. 18, 2008

(30) Foreign Application Priority Data
Dec. 8, 2005 (DE) 10 2005 058 531.0

(51) Int. Cl. F16F 15/16; F16D 3/80

(52) U.S. Cl. 74/573.11; 464/27

(57) ABSTRACT

A torsional vibration damper has a drive side transmission element connected to a drive; a takeoff side transmission element, which can be brought into working connection with a takeoff and which can rotate with respect to the drive side transmission element; and a damping device installed between the two transmission elements, the damping device being equipped with a spring system, which serves to transmit torque between the drive side and the takeoff side transmission element and has at least one reservoir space containing a gaseous medium. Each reservoir space of the spring system is in working connection with an assigned pressure space of a pressure circuit containing a fluid medium, where the pressure circuit can be used to adjust the pressure present in the pressure space when the torque to be transmitted by the spring system changes and thus to adapt the characteristic of the spring system to the new torque as needed.

The invention pertains to a torsional vibration damper according to the introductory clause of Claim 1.

DE 102 56 191 A1 discloses a torsional vibration damper with a drive side transmission element; a takeoff side transmission element, which can be deflected rotationally with respect to the drive side element around essentially the same axis of rotation; and a damping device installed between the two transmission elements.

The drive side transmission element is connected to a drive such as the crankshaft of an internal combustion engine, whereas the takeoff side transmission element can be brought into working connection with a takeoff such as a gearbox input shaft by way of a clutch device, such as an engageable and disengageable friction clutch. So that torque can be transmitted between the drive side transmission element and the takeoff side transmission element, the damping device is provided both with a spring system, comprising a plurality of gas springs, and a supplemental spring system, containing a plurality of steel springs. When torsional vibrations occur, the steel springs are deformed and thus convert hard jolts into a softer vibration process in the known manner. The gas springs are responsible for a damping process which absorbs the energy of the jolts. For this purpose, each of the gas springs has a reservoir space containing a gaseous medium such as air inside a cylinder space. When the gas spring is compressed and thus the volume of the reservoir space is decreased, the gaseous medium is forced out of the reservoir space through a throttle opening. Of course, when the load on the gas spring is released and thus the volume of the reservoir space increases again, fresh gaseous medium is drawn back in from the environment through the throttle opening. This makes it possible to achieve velocity-proportional damping without any special sealing requirements.

The pressure in the reservoir space and thus the damping behavior of the known spring system are the result of the deformation state at the moment in question. This spring system is therefore referred to in engineering circles as a “passive” system. The throttle opening is designed for all conceivable load states and therefore represents only a compromise. Steel springs suffer from the same problem, namely, that certain compromises must be made when adapting their spring characteristics to the different load states which occur during operation.

To remedy this problem in the case of steel springs, DE 41 28 868 A1 describes the possibility of arranging a plurality of springs in a row in the circumferential direction and of providing the individual steel springs with different characteristics, so that, when small torques are introduced, only the steel springs with lower characteristics are compressed, whereas, when larger torques are introduced, the steel springs with the higher characteristics will be compressed as well. The problem here, however, is that steel springs are affected by the rotational speed. That is, their turns are forced radially outward by centrifugal force, and they can then become immobilized in this radial position. Torsional vibrations therefore do not necessarily lead to the compression of the adjacent steel spring, i.e., adjacent in the direction in which the torsional vibrations are being introduced, which means that the damping device may not provide any damping effect at all at first. Only an even higher load state will finally be able to break the steel spring loose from its radially outer immobilized position, which will be perceived in the vehicle as an unpleasant jerk. The process is interrupted again temporarily at the circumferentially adjacent steel spring, which may have a steeper characteristic, until this spring, too, breaks loose from its radially outer position under the effect of an even greater load. When operateing in this way, therefore, the overall result is that only a certain percentage of the spring system, never the entire volume, is available. The severity of this problem can be reduced but not eliminated by the sliding elements proposed in DE 41 28 868 A1, which are inserted between the steel springs and their radially outer contact points. The quality with which torsional vibration dampers of this type isolate vibrations is therefore inadequate, and because of the high stiffnesses in the damping device, they have a resonance frequency in an rpm range which is present relatively often when a vehicle is being driven. Especially critical here is the lower range between 1,000 and 2,000 rpm when at the same time engine torques are high and the torsional vibrations which are being excited are correspondingly strong. Under such conditions, droning noises are heard in the vehicle.

The invention is based on the task of designing a damping device for a torsional vibration damper in such a way that undesirable droning noises can be avoided even under extreme conditions.

This task is accomplished according to Claim 1. Through the presence of a fluid medium-filled, e.g., hydraulic medium-filled, pressure space, which is assigned to a spring system reservoir space filled with a gaseous medium such as air, and which is connected to a pressure circuit, an “active” hydropneumatic spring system is created, which makes it possible to readjust the pressure present in the pressure space and thus also the pressure in the reservoir space when the torque to be transmitted by the spring system changes and thus to adapt the characteristic of the spring system to the new torque as needed. In engineering circles, a distinction is made between a “fully active” and a “partially active” spring system. In the case of a fully active spring system, an adjustment is made immediately by supplying fluid medium to the pressure space or by removing it from the pressure space whenever the driving situation causes a change in the engine torque. In the case of a partially active spring system, however, an adjustment occurs only when there is a major change in engine torque. Otherwise, the spring system operates without any adjustments in a manner comparable to that of a passive spring system. Partially active spring systems thus perform a much smaller number of control processes than fully active systems, and the associated demand for a fast adjustment speed is also reduced. As a result, partially active systems offer the advantage of being able to work with slower flow velocities than fully active systems during the displacement of fluid medium between the pressure circuit and the pressure space. Partially active spring systems are also characterized by low energy consumption and require only limited reservoir space capacity for fluid medium or perhaps no such reservoir capacity at all. The power of the pump used in a partially active gas spring system can be lower than that in a fully active spring system.

The characteristic of the spring system is preferably adapted to a change in torque by readjusting the pressure present in the pressure space of the spring system and thus in the control space of the spring system as a function of conditions which are relevant to the vehicle and/or to the driving situation. If the pressure circuit works here with an closed-loop and/or open-loop control device, referred to in the following simply as “automatic control”, then this automatic control can, for example, rely on operating points stored in the vehicle control system and accordingly supply the pressure space with fluid medium at a rate which is always appropriate to the specific conditions relevant to the vehicle and/or to the driving situation. The positive pressure present in the gaseous medium-filled reservoir space and thus the characteristic of the spring system are adjusted in each case on the basis of the positive pressure thus present in the pressure space. As a result, whatever the value of the torque which may be introduced into the torsional vibration damper—during operation in pull mode, the torque introduced by a drive such as the crankshaft of an internal combustion engine, or, in the case of operation in push mode, the torque introduced by a takeoff such as a gearbox input shaft—a spring characteristic corresponding to that torque will always be available in the spring system, which means in turn that at least most if not all of the compression distance of the spring system is available at all times. The characteristics of purely passive spring systems are calculated in such a way that, even when the torques are low, the available spring travel will allow the transmission elements to deflect with respect to each other, but this same amount of spring travel is all that there is available is to deal with the highest torques. In the case of the inventive active spring system, however, the characteristic is adjusted continuously to the specific torque present at the moment, which in practice results in a “virtual” quadrupling of the available spring travel. The quality with which this torsional vibration damper isolates vibrations is correspondingly high, and its resonance frequency is correspondingly low, so low, in fact, that it is outside the typical rpm range of a vehicle under normal driving conditions.

If resonance-related behavior should occur in spite of the previously mentioned low resonance frequency of the torsional vibration damper, the pressure in the pressure space and thus in the reservoir space can be raised to a level, such as to the level of maximum pretension, and kept at this level, so that the relative rotational movement of the transmission elements of the torsional vibration damper which are able to turn relative to each other is prevented or at least almost completely prevented. Damage to the damping device can be effectively avoided by delaying the reduction of the pressure and thus the pretension of the spring system until a predetermined time interval has expired. It is also advantageous to raise the pressure in the pressure space and thus in the reservoir space to a level, for example, of maximum pretension when the cylinders are shut down and operation is proceeding at orders below excitation of ignition.

The same procedure is also effective when, during periods of continuous load changes, a supply reservoir installed between the spring system and the pump is completely emptied as a result of continuous transitions between increases and decreases in pressure and the pump alone is unable to provide the volume flow rate of fluid medium necessary to ensure the rapid succession of required pressure changes in the pressure space.

As an alternative to this approach or in addition to it, a rotational angle limiter can be assigned to the spring system in question. Together with the spring system, especially together with the cylinder of the spring system, this limiter is mounted on one of the transmission elements of the torsional vibration damper, whereas a driver element, which works together with the rotational angle limiter, is mounted on the other transmission element of the torsional vibration damper to drive a control piston, which moves back and forth inside the cylinder. When large rotational deflections now occur between the two transmission elements, the driver element is deflected in the circumferential direction relative to the cylinder until it comes to rest against the rotational limiter, and thus no further relative deflection of the two transmission elements is possible. This rotational angle limiter is preferably provided with a seal to prevent the escape of gaseous and/or fluid medium at the point of relative movement between the two transmission elements.

The previously mentioned supply reservoir can be filled with fluid medium by the pump. As a result of this supply reservoir, it is possible to provide a high volume flow rate and thus to bring about a considerable increase in the pressure in the pressure space in a very short period of time. A low-pressure reservoir can be provided between the pressure space and the pump so that a significant decrease in pressure in the pressure space can also be obtained in a very short period of time. Between said reservoirs and the pressure space, it is advantageous to install correcting elements such as valves, the open cross sections of which can be adjusted to automatically control the pressure circuit and thus to influence the increases and decreases in pressure.

Even though the spring travel of the inventive torsional vibration damper is effectively very long, the actual amount of space which the spring system occupies and its mass moment of inertia are small. Independently of this, the spring travel can be made even longer without loss of the previously mentioned advantages by providing an additional reservoir space to increase the capacity of the main reservoir space of the spring system, this additional space being pressure-connected to the main reservoir space. The extent to which the spring stiffness can be lowered to adapt it to the torque in question can therefore be increased even more, which means that vibrations can be isolated with even greater quality.

To establish a pressure connection between an essentially stationary pressure circuit component and the spring system which follows the rotational movements of the transmission elements around a common axis of rotation, it is advantageous to use at least one rotary lead-through. This advantageously has a pressure guide element, which can be assigned either to the drive or to the takeoff.

If the external pressure circuit component is assigned to the takeoff, at least two rotary lead-throughs are required, namely, a first located between the pressure circuit component and the takeoff, and a second, located between the latter and the corresponding transmission element, preferably therefore the drive side transmission element. A feed line assigned to the drive side transmission element can be used to conduct the fluid medium onward into the spring system.

The spring system is designed with a reservoir space for the gaseous medium which allows the spring action, for which reason the term “gas spring” is used in the following. Although a gas spring requires a certain base pressure and thus must have a certain minimum pretension, which depends on the system, nevertheless a characteristic can be generated which corresponds to a spring under no pretension at all. This can be done by providing two gas springs, which are arranged to work in opposition to each other. As a result of this measure, the system can react to even very small changes in torque, and in addition the torsional vibration damper is equally suitable for operation in both pull mode and push mode.

It can be advantageous to design each cylinder of the spring system in question both for pull mode and for push mode operation. For this purpose, for example, the individual components of the cylinder space, namely, the control pistons, the sealing chambers, and the secondary separating pistons, are arranged in mirror-image fashion with respect to the center of the cylinder, the two groups being separated from each other by a common control chamber. The components of the two cylinder halves can also have a common pressure space and separating pistons between the pressure space and the reservoir space and possibly also a secondary reservoir space assigned to the main reservoir space. The individual components of the two cylinder halves are preferably designed with low mass, so that they can react with low inertia when torsional vibrations are introduced and when rapid changes occur in the torque to be transmitted, and also so that the inertia of the entire cylinder receptacle can be kept within limits. It is advantageous for this purpose to design the control piston with thin walls.

The spring system can be in working connection with the drive side transmission element and/or with the takeoff side transmission element. It is preferable for both the gas-filled cylinder space of the cylinder in question and the fluid-filled pressure space to be located at least essentially in the drive side transmission element, whereas a pressure-setting device which adjusts the pressure in the pressure space is installed essentially in the takeoff side transmission element.

According to an advantageous embodiment, the pressure-setting device can be formed by a fluid displacer, which is installed with freedom of movement, e.g., freedom of relative rotation or of circumferential movement, in a fluid holding chamber, which serves as a pressure space, or by changing the pressure at a pressure space connection assigned to the pressure space.

Because the spring system has at least one fluid-filled pressure space and at least one gas-filled reservoir space, these spaces are each isolated from each other by separating pistons, possibly also by secondary separating pistons. The viscous medium of the pressure space in question not only serves to build up the pressure but also to lubricate any seal which may be assigned to the separating piston or to the secondary separating piston. The essential point of lubricating the seal is to minimize the “break-loose” torque of the seal, that is, the torque at which the separating piston no longer adheres as a result of the friction between the seal and the walls of its space but rather breaks loose and is free to slide. As a result, the separating piston can be deflected softly even at very small load changes.

It can be advisable to provide an axial energy storage device axially between the transmission elements of the torsional vibration damper. It can be installed, for example, between a driver element carrier, which has driver elements for the associated spring system, and a takeoff side flywheel mass. As a result, the driver element carrier and thus the driver elements are pretensioned toward the drive side, which can be advantageous when a spring-loaded friction clutch is mounted on the takeoff side flywheel mass.

According to another embodiment it, it can be advantageous to install the cylinders of the spring system with freedom of circumferential movement in a carrier device. The carrier device is able to rotate relative to the two transmission elements and is centered with respect to them. The carrier device has access openings for the driver elements of at least one of the transmission elements, preferably the drive side transmission element. When the cylinders are installed in this way, only one control piston is required to realize both possible directions of rotation, i.e., that during push-mode operation and that during pull-mode operation, because, instead of a secondary control piston which would otherwise have to be installed in the cylinder, the entire cylinder can shift position in the circumferential direction. For this purpose, each cylinder is designed with a centering segment, which positions the cylinder radially and axially in the carrier device but does not interfere with its ability to move in the circumferential direction relative to the centering segment. With this design, spring-loaded movements are possible either through displacement of the control piston with respect to the cylinder surrounding the control piston under the action of a driver element of one of the transmission elements or by displacement of the cylinder with respect to the control piston under the action of a driver element of the other transmission element. Overall, it is possible with this design to actuate not only the previously mentioned second control piston but also the sealing chamber assigned to it and the separating piston also assigned to the second control piston.

According to another embodiment of the invention, the main pressure space section of the pressure space has a control piston at each of its circumferential ends and is connected by at least one pressure space passage to the secondary pressure space section of the pressure space, which is in working connection with the reservoir space by way of a sealing chamber and a separating piston. The fluid lines leading from the pressure guide element by way of the second rotary lead-through to the main pressure space section are accommodated and secured against movement in the area of at least one of the control pistons by means of pressure space connections. In this embodiment, the pressure-setting device is exclusively hydraulic, so that the separating piston present in any case in the reservoir space takes over completely the job of compressing the viscous medium in the reservoir space. There is thus no need for yet another separating piston in the reservoir space.

The invention is described on the basis of the exemplary embodiments shown in the drawing:

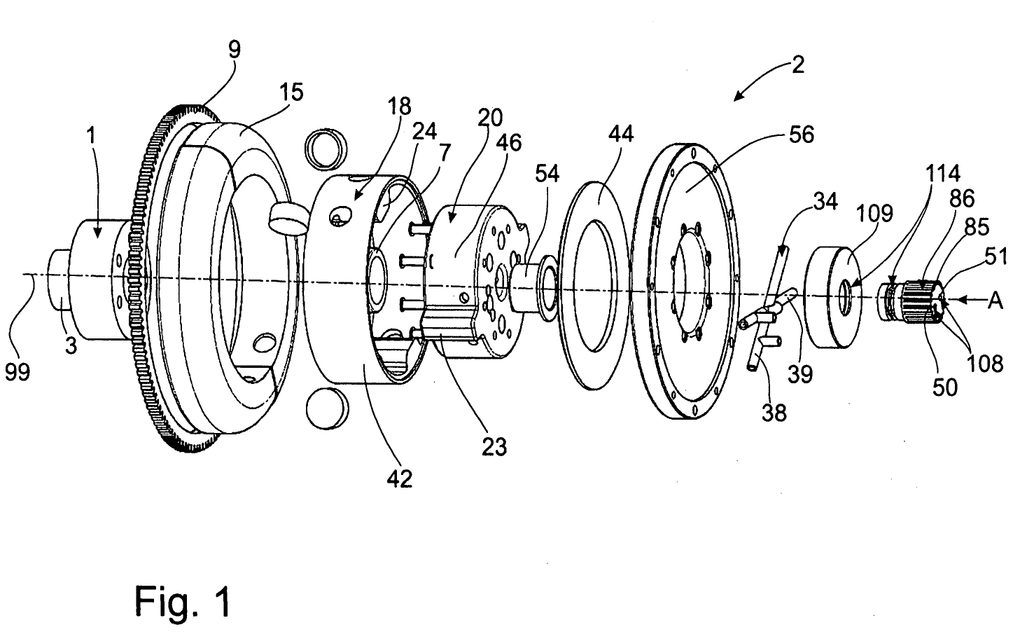

FIG. 1 shows an exploded view of a torsional vibration damper with a hydropneumatic spring system, in which a fluid displacer forms a pressure-setting device;

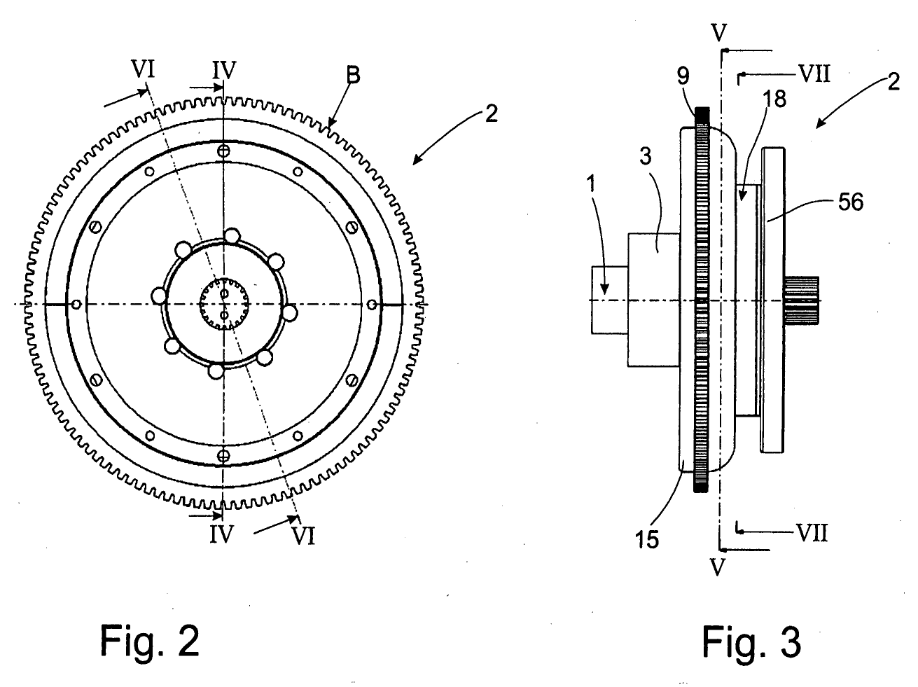

FIG. 2 shows a view of the torsional vibration damper in direction A of FIG. 1;

FIG. 3 shows a view of the torsional vibration damper in direction B of FIG. 2;

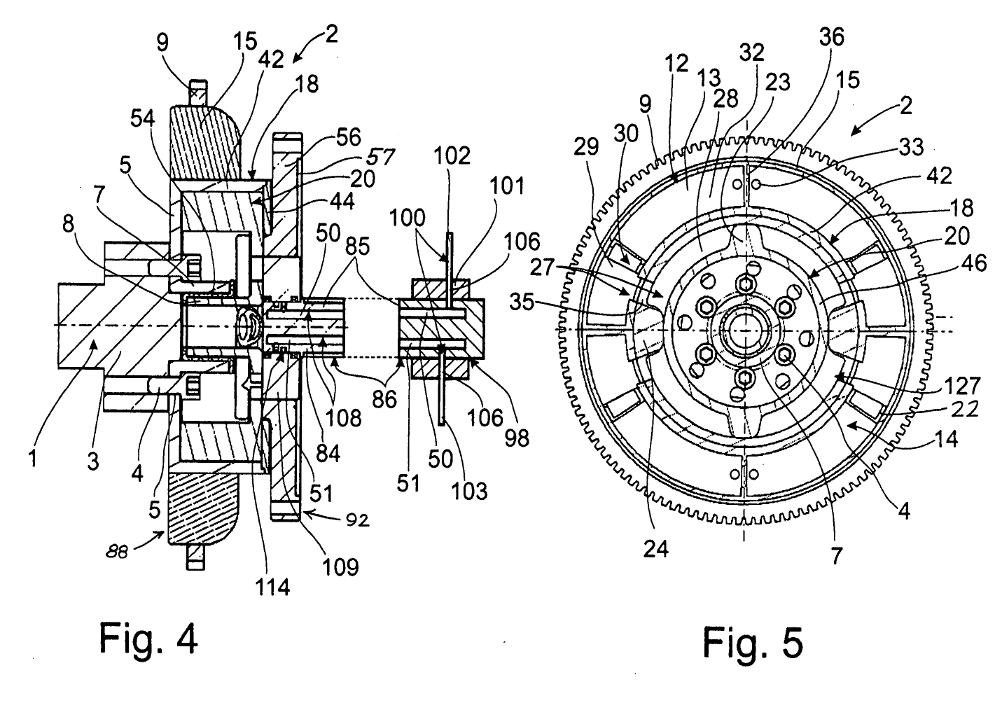

FIG. 4 shows a cross-sectional view along line IV-IV of FIG. 2;

FIG. 5 shows a cross-sectional view along line V-V of FIG. 3;

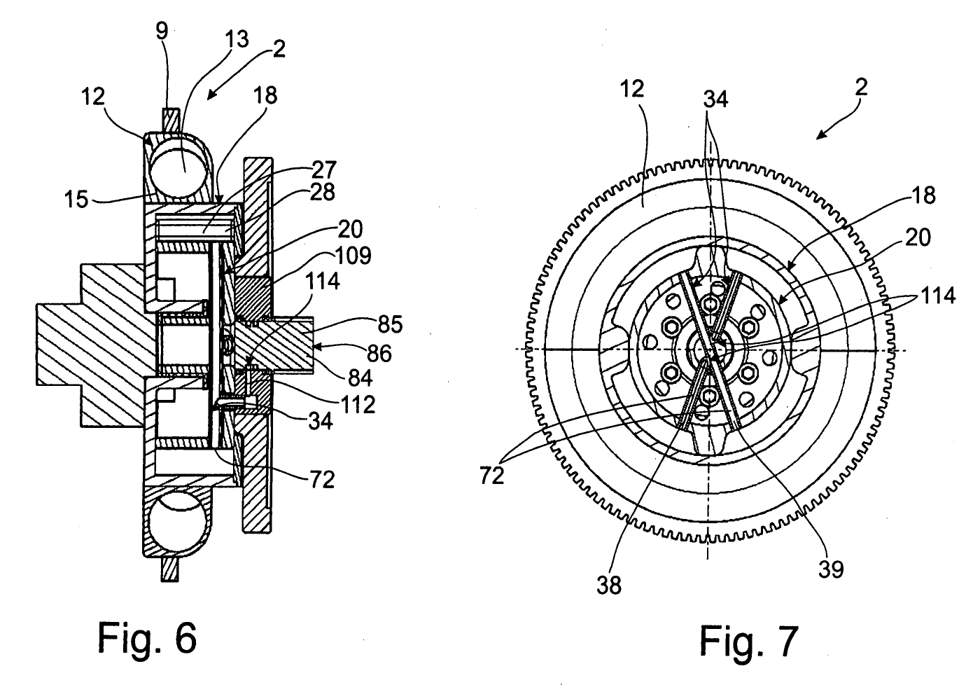

FIG. 6 shows a cross-sectional view along line VI-VI of FIG. 2;

FIG. 7 shows a cross-sectional view along line VII-VII of FIG. 3;

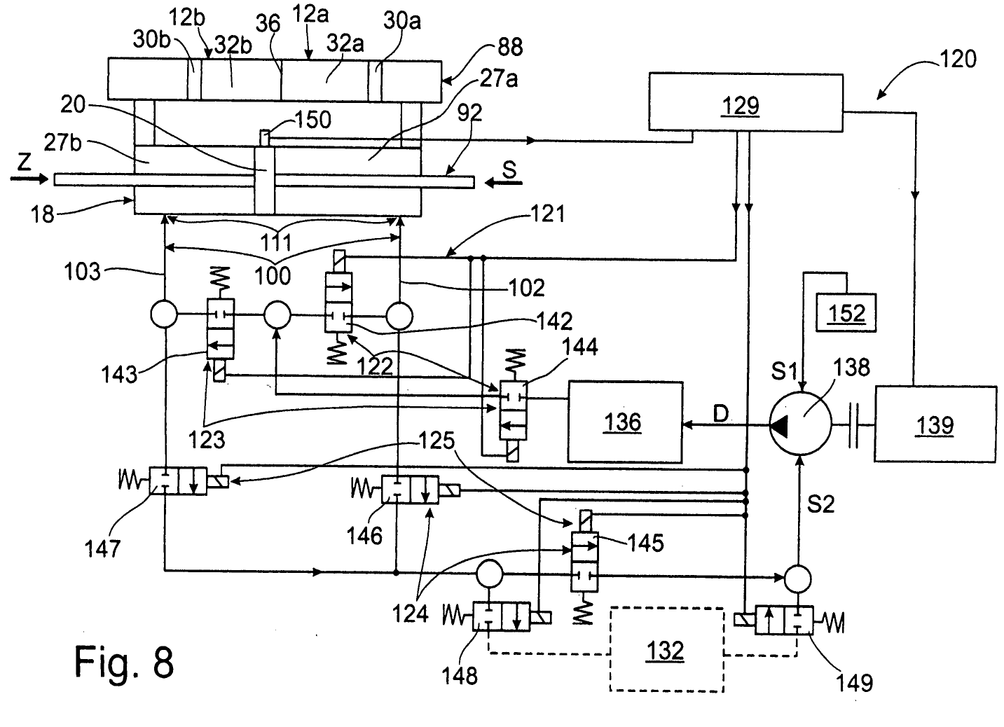

FIG. 8 shows a schematic diagram of a pressure circuit for supplying the spring system with fluid medium;

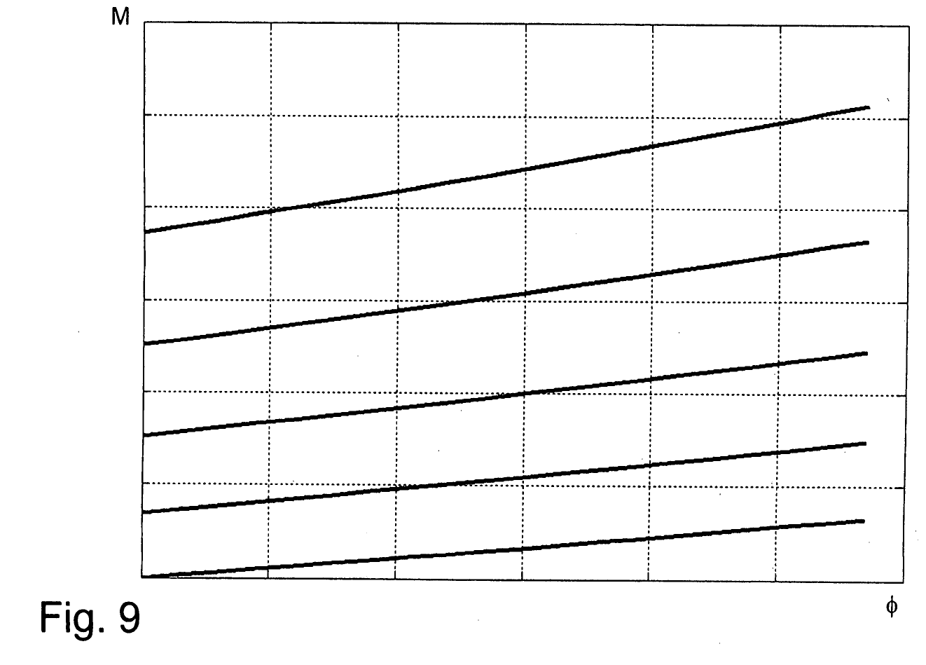

FIG. 9 shows a graph of spring system characteristics;

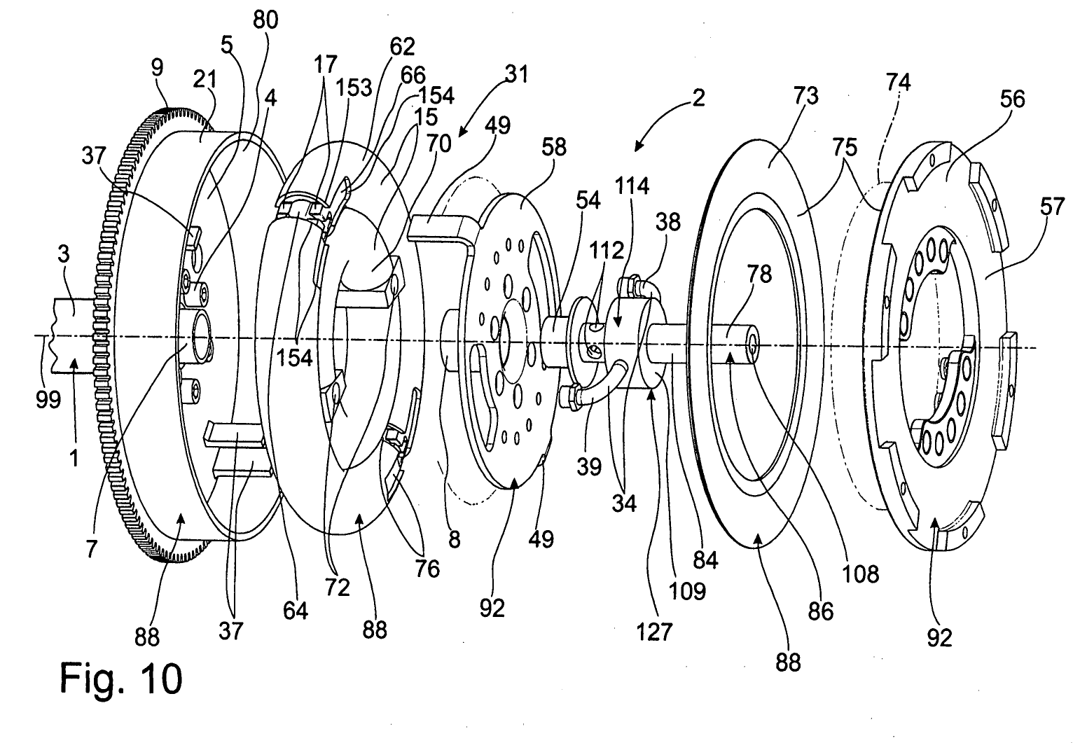

FIG. 10 shows an exploded view of another design of the torsional vibration damper and of the spring system;

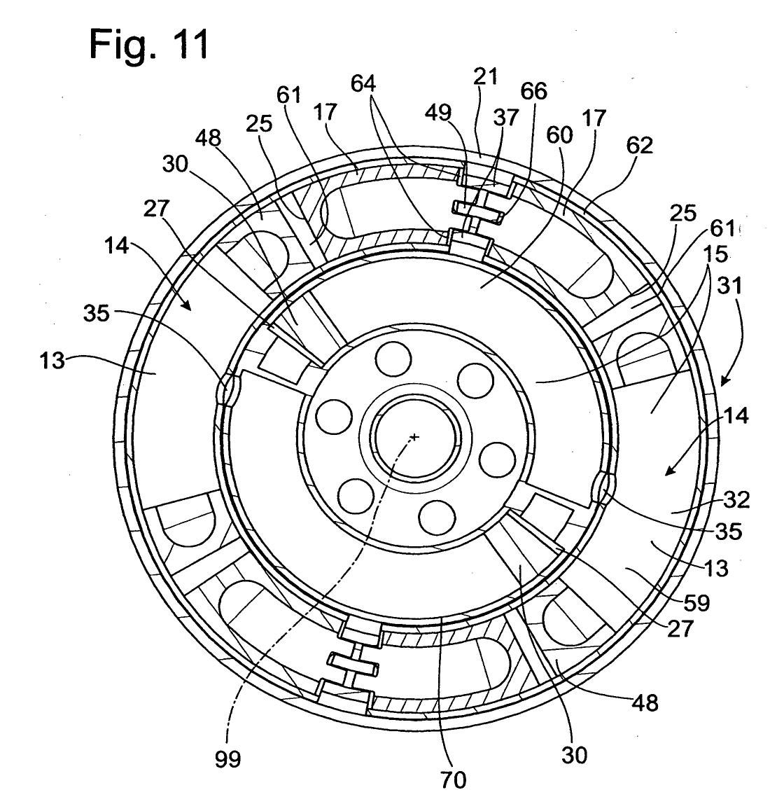

FIG. 11 shows a cross-sectional view of a drive side transmission element of the torsional vibration damper in direction A of FIG. 10;

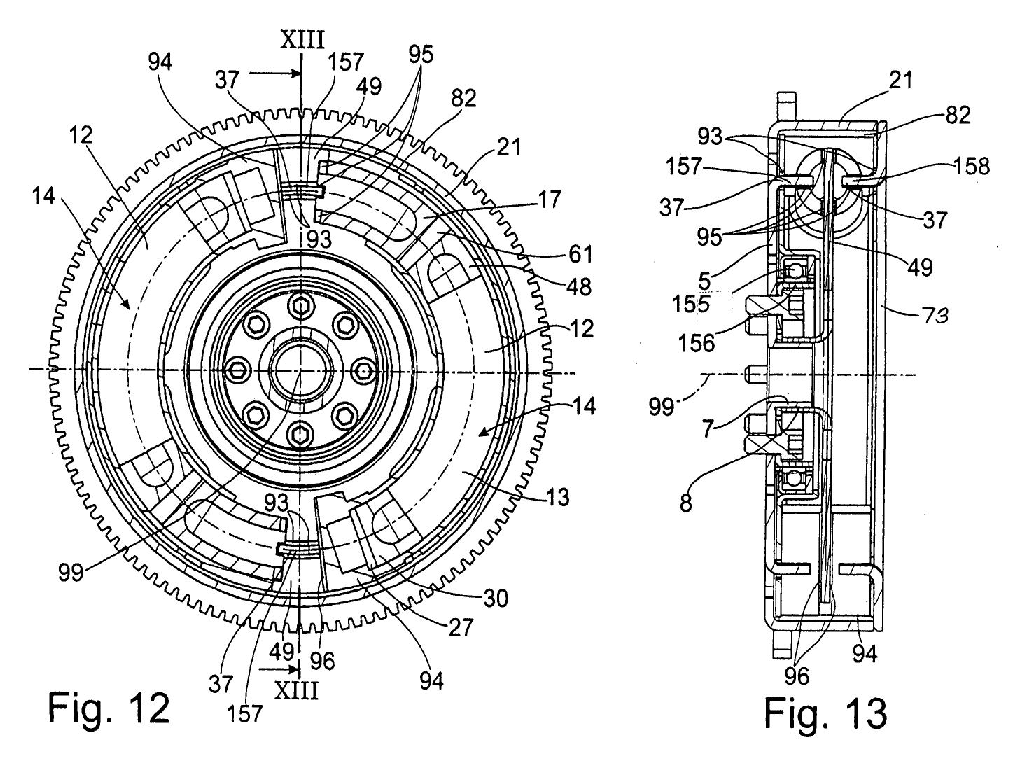

FIG. 12 is similar to FIG. 11 except that it shows another design of the torsional vibration damper;

FIG. 13 shows a cross-sectional view of the torsional vibration damper along line XIII-XIII of FIG. 12;

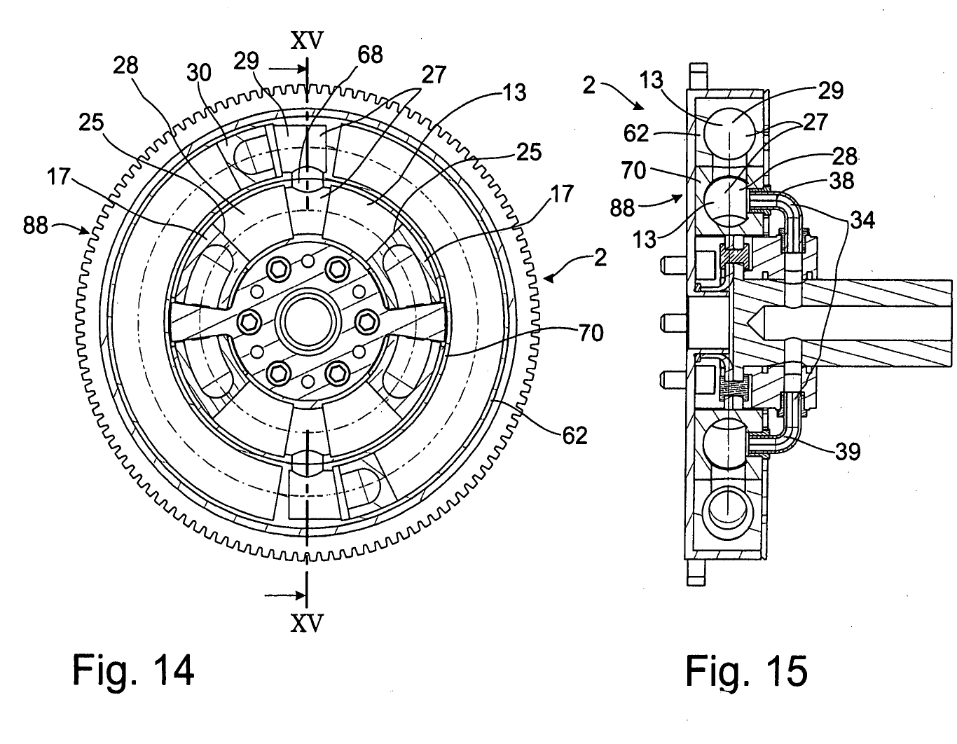

FIG. 14 is similar to FIG. 11, except that it shows a further design of the torsional vibration damper;

FIG. 15 shows a cross-sectional view of the torsional vibration damper along line XV-XV of FIG. 14;

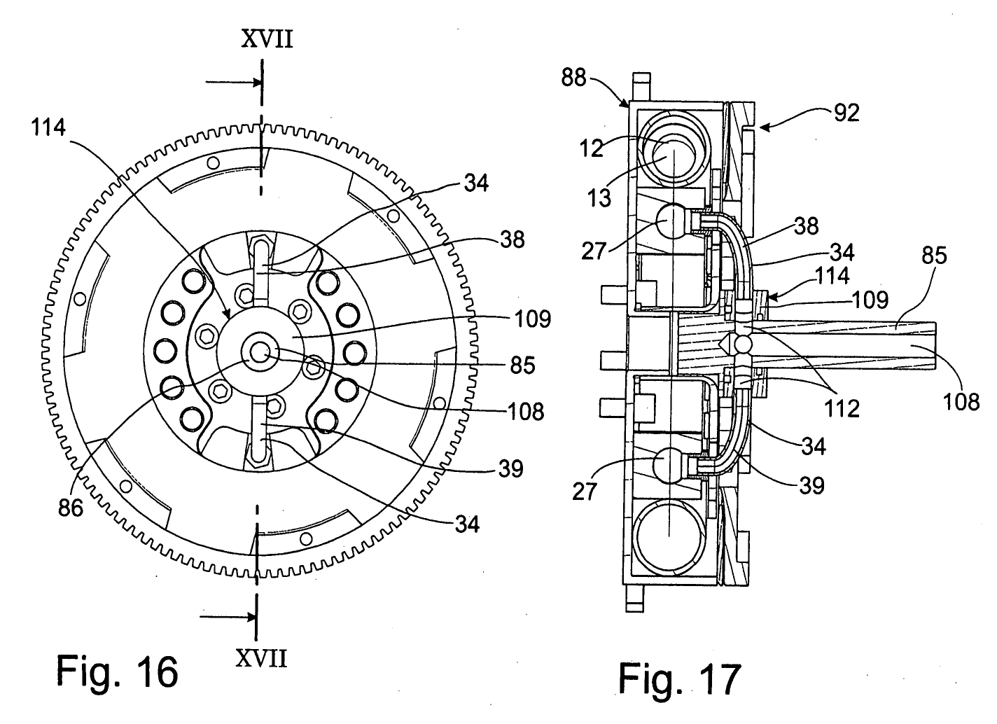

FIG. 16 shows a view of the feed route of viscous medium in the design of the torsional vibration damper according to FIGS. 10 and 11 in viewing direction A of FIG. 10; and

FIG. 17 shows a cross-sectional view of the torsional vibration damper along line XVII-XVII of FIG. 16.

FIGS. 1-7 shows a torsional vibration damper 2, which, as can be seen best in FIG. 4, is fastened to a drive 1, preferably in the form of a crankshaft 3 of an internal combustion engine, by means of fastening elements 4. The fastening elements 4 pass through openings 5 in a radial flange 5, which cooperates with a circumferential ring 42 and a cover plate 44 to form a fluid holding chamber 18, which encloses a fluid displacer 20. The radial flange 5 also has a primary hub 7 in the radially inner area; acting by way of a bearing 54, this primary hub centers and axially positions the secondary hub 8 of the fluid displacer 20.

A cylindrical receptacle 15 is fastened to the fluid holding chamber 18 in such a way as to enclose it radially. A gear ring 9 is mounted on the outside circumference of the cylindrical receptacle. The receptacle holds hydropneumatic spring systems 14 in the form of cylinders 12 (FIG. 5), each of which has cylinder spaces 13 (FIG. 6) with a circular cross section. In the design of the torsional vibration damper 2 shown in FIG. 5, four of these cylinders 12 are provided around the circumference; there are thus two pairs of cylinders, the two cylinders of each pair working in opposition to each other. Thus one cylinder 12 is designed to deflect in a first direction for pull-mode operation, and the opposite cylinder 12 is designed to deflect in the second direction for push-mode operation. The same situation applies to the two other cylinders 12.

Each spring system 14 is formed out of a reservoir space 32, filled with a gaseous medium such as air; a pressure space section 29 of a pressure space 27, filled with a fluid medium such as hydraulic fluid; and a separating piston 30, which isolates the two spaces 27, 32 from each other by means of a seal 22, and which, with respect to its geometry, conforms at least essentially to the cross-sectional form of the cylinder spaces 13. It remains to be mentioned that each of the individual reservoir spaces 32 has a reservoir connection 33, which allows gaseous medium to be supplied or removed, and the two opposing reservoir, spaces 32 of each pair are isolated from each other by a stationary partition wall 36.

The pressure space section 29 is connected to a pressure space section 28 of the pressure space 27 by a reservoir passage 35. The pressure space section 28 extends radially between the circumferential ring 42 of the fluid holding chamber 18 and the support ring 46 of the fluid displacer 20. In the circumferential direction, the pressure space section 28 extends between a fluid displacer element 23, which is provided on the support ring 46 and projects toward the circumferential ring 42, and a fluid control element 24, which is provided on the circumferential ring 42 and projects toward the support ring 46. The pressure space section 28 serves as the primary pressure space section, and the pressure space section 29 serves as the secondary pressure space section of the pressure space 27. Before we discuss in detail how the pressure space 27 is supplied with viscous medium, it should be pointed out that the fluid holding chamber 20 is used to establish a nonrotatable connection with a takeoff side flywheel mass 56, which has a friction surface 57 with which a clutch disk of a friction clutch can be brought into contact in the known manner and which therefore requires no explanation here. In this way, when the friction clutch is engaged, it is possible for torque to be transmitted between the drive 1 and the takeoff 86, or, when the friction clutch is disengaged, to interrupt this transmission of torque. A friction clutch of this type in conjunction with a takeoff side flywheel mass is known from DE 10 2004 012 425 A1, for example, so that, in this respect, the content of this publication is to be considered integrated into the present application. The drive side transmission element 88 of the torsional vibration damper 2 is to be formed by the drive 1 in conjunction with the fluid holding chamber 18 and the cylinder receptacle 14, including the gear ring 9; whereas the takeoff side transmission element 92 of the torsional vibration damper 2 is to be formed by the fluid displacer 18 in conjunction with the takeoff side flywheel mass 56, the friction clutch (not shown), the second rotary lead-through 104, and the takeoff 86. The two transmission elements 88, 92 are each centered with respect to essentially the same axis of rotation 99.

The previously mentioned arrangement of the gear ring 9 on the drive side transmission element 88 is advantageous for the following reason: During the starting phase, the drive side transmission element 88 is deflected, whereas the takeoff side transmission element 92 remains stationary. This causes fluid medium to be pumped from the supply reservoir 136, as a result of which the pretension in the spring systems 14 is increased. The pretension is directed in such a way that the spring systems 14 assist the starting phase. If this effect is not desired, the gear ring 9 can, alternatively, be mounted on the takeoff side transmission element 92.

The pressure spaces 27, and especially here the main pressure space sections 28, are each connected by a feed line 34 comprising fluid lines 38 and 39 (FIGS. 6 and 7) to radial passages 112 in a pressure circuit component 109. The radial passages are pressure-connected to flow channels 50, 51 (FIG. 4), serving as an integrated pressure line 108, of a takeoff 86 in the form of a gearbox input shaft 84, which also serves as a pressure guide element 85. By means of radial channels 106 in a pressure circuit component 101, the flow channels 50, 51 are pressure-connected at the other end to a feed line 100, formed by fluid lines 102 and 103. The takeoff side pressure circuit component 101 works together with the takeoff 86 to form the first rotary lead-through 98, whereas the drive side pressure circuit component 109 works together with the takeoff to form the second rotary lead-through 114.

The torsional vibration damper 2 cooperates by way of the first rotary lead-through 98 with a pressure circuit section 121 of a pressure circuit 120, shown merely schematically in FIG. 8. At the inflow end, the fluid line 102 is connected by a correcting element 142 to a correcting element 144, whereas the fluid line 103 is connected to the same correcting element 144 by way of a correcting element 143. The correcting element 144 itself is connected to the pressure output D of a pump 138 by way of a supply reservoir 136, in which a predetermined positive pressure can be built up. The pump is connected to a pump drive 139 in the form of an electric motor. A first suction port S1 of the pump 138 is connected to a pressure source 152, and a second suction port S2 is connected to a correcting element 145. The correcting element 145 is connected either by way of a correcting element 146 to the fluid line 102 or by way of a correcting element 147 to the fluid line 103. Alternatively, the correcting elements 146, 147 can also be connected by way of a correcting element 148 to a low-pressure reservoir 132, which is connected by way of a correcting element 149 to the second suction port S2 of the pump 138. All of the correcting elements 142-149, the pump drive 139, and a sensor 150, which is attached to the fluid displacer 20 to indicate its relative rotational deflection versus the fluid holding chamber 20, are connected to an automatic control device 129, referred to in brief in the following as the “control system” 129. The control system 129 receives signals from the sensor 150 and sends signals which determine the operation of the pump drive 139 and the positions to which the electromagnets of the correcting elements 142-149 are switched. The correcting elements 142 and 144 form a first correcting element group 122; the correcting elements 143 and 144 form a second correcting element group 123; the correcting elements 145 and 146 form a third correcting element group 124; and the correcting elements 145 and 147 form a fourth correcting element group 124.

In the following description of the way in which the gas spring system 14 functions in conjunction with the pressure circuit 120, the index “a” is added to the reference number in question for the components of the gas spring system 14 which are assigned to operation in pull mode, whereas the index “b” is used for the components of the gas spring system 14 which are assigned to operation in push mode. The components of the gas spring system 14 in FIG. 8 are designated in the same way, although the gas spring system 14 in this figure is shown merely in schematic fashion.

During operation in pull mode, the drive side transmission element 88 and thus the fluid holding chamber 18 are deflected in a direction in which a force acts on the fluid displacer 20 as indicated by the arrow “Z” in FIG. 8. As a result, the viscous medium present in the pressure space 27a is displaced toward the reservoir space 32a, and the separating piston 30a is thus shifted toward the partition wall 36. The gaseous medium present in the reservoir space 32a is thus compressed, and the impact of the torque which has been introduced is cushioned. Conversely, during operation in push mode, the takeoff side transmission element 92 and thus the fluid displacer 20 are deflected in a direction in which a force acts on the fluid displacer 20 as indicated in FIG. 8 by the arrow “S”. As a result, the viscous medium present in the pressure space 27b is displaced toward the reservoir 32b, and the separating piston 30b is shifted toward the partition wall 36. The gaseous medium present in the reservoir 32b is thus compressed, and the impact of the torque which has been introduced is cushioned.

To increase the pressure in the pressure space 27a, the correcting elements 142 and 144 of the first correcting element group 122 are set to “open” by the control system 129, so that viscous medium which has collected in the supply reservoir 136 is conducted into the pressure space 27a, with the effect of shifting the separating piston 30a toward the partition wall 36. As a result, the pressure in the reservoir space 32a also increases, so that the effect of a higher spring stiffness is obtained. In this phase, the correcting elements 145 and 146 of the third correcting element group 124 are moved into their blocking position, in which the passage of viscous medium is prevented. During this phase, the pump 138 can also accept fresh viscous medium through its first suction port S1 from the pressure source 152 and thus ensure the refilling of the supply reservoir 136.

To decrease the pressure in the pressure space 27a, conversely, the correcting elements 142 and 144 of the first correcting element group 122 are moved into their blocking position. The correcting elements 145 and 146 of the third correcting element group 124, however, are set to “open”. In this way, viscous medium can be drawn from the pressure space 27a via the third correcting element group 124 and the second suction port S2, so that the pump 138 can conduct it to the supply reservoir 136 and/or to the pressure source 152. Alternatively, the viscous medium can be conducted via the correcting elements 146 and 148 to the low-pressure reservoir 132 and from there via the correcting element 149 to the second suction port S2 of the pump 138, where it is drawn off. The low-pressure reservoir 132 can accelerate the withdrawal of the viscous medium out of the pressure space 27a. As a result of this measure, the pressure in the reservoir 32a is lowered, so that the effect of a lower spring stiffness is obtained.

To increase the pressure in the pressure space 27b, the correcting elements 143 and 144 of the second correcting element group 123 are set by the control system 129 to “open”, so that the viscous medium which has collected in the supply reservoir 136 is conducted into the pressure space 27b, and the separating piston 30b is thus shifted toward the partition wall 36. As a result, the pressure in the reservoir 32b also increases, so that the effect of a higher spring stiffness is obtained. In this phase, the correcting elements 145 and 147 of the fourth correcting element group 125 are moved into their blocking position, in which the passage of viscous medium is prevented. During this process, the pump 138 can also accept fresh viscous medium via its first suction port S1 from the pressure source 152 and thus ensure the refilling of the supply reservoir 136.

To decrease the pressure in the pressure space 27b, conversely, the correcting elements 143 and 145 of the second correcting element group 123 are moved into their blocking position, whereas the correcting elements 145 and 147 of the fourth correcting element group 125 are set to “open”. In this way, viscous medium can be drawn from the pressure space 27b via the fourth correcting element group 125 and the second suction port S2, so that the pump 138 can conduct it to the supply reservoir 136 and/or the pressure source 152. Alternatively, the viscous medium can also be conducted via the correcting elements 146 and 148 to the low-pressure reservoir 132 and from there via the correcting element 149 to the second suction port S2 of the pump 138, where it is drawn off. The low-pressure reservoir 132 can accelerate the withdrawal of the viscous medium from the pressure space 27b via the fourth correcting element group 125. As a result of this measure, the pressure in the reservoir 32b can be lowered, so that the effect of a lower spring stiffness is obtained.

After the fluid medium which has been introduced via one of the fluid lines 102 or 103 of the feed line 100 of the pressure circuit 120 has flowed through the first rotary lead-through 98 (FIG. 4), it is conducted onward through the flow channels 50, 51 of the integrated pressure line 108 of the takeoff 86 to the second rotary lead-through 114, from which it proceeds via the fluid lines 38, 39 (FIG. 7) of the feed line 34 to the spring system 14. The higher the pressure in the pressure space 27 resulting from the introduced fluid medium, the greater the pressure of the gaseous medium in the reservoir space 32 of the spring system 14 as a result of the displacement of the separating piston 30 (FIG. 5) toward the partition wall 36 and thus the greater the amount of torque which can be transmitted by this spring system 14. The characteristic curve of the spring system 14 shown in FIG. 9 is thus adapted to the associated value of the torque to be transmitted. As a result of this adaptation, the characteristic optimally adapted to the load state in question is realized, so that, in practice, the entire spring travel of which the spring system 14 is capable in the presence of this characteristic is available for the damping of any torsional vibrations which may be caused by alternating loads. Of course, a further increase in the load can be compensated by an even higher pressure in the pressure space 27 and therefore in the reservoir space 32 and thus an even higher characteristic can be realized, whereas a decrease in the load can be compensated by lowering the pressure in the pressure space 27 and therefore in the reservoir space 32, which leads to the realization of a lower characteristic. It remains to be noted that FIG. 9 shows the characteristics as a function of the associated torque M, relative to the deflection angle φ provided by the spring system 14. The transition between the individual characteristics can occur in large, predefined steps or in a manner which is at least essentially continuous.

FIGS. 10 and 11 as well as FIGS. 16 and 17 show another embodiment of the torsional vibration damper 2. In this embodiment, the torsional vibration damper 2, as seen best in FIG. 10, is again fastened to the drive 1, preferably in the form of a crankshaft 3 of an internal combustion engine, by means of connecting elements 4. The connecting elements 4 pass through the radial flange 5, which, together with an axial shoulder 21 and a cover element 73, forms a receiving space 80 for the spring systems 14. The radial flange 5 has the primary hub 7 in the radially inner area. By way of a bearing 54, this primary hub 7 centers and axially positions the secondary hub 8 of the driver element carrier 58.

A cylinder receptacle 15, which is connected nonrotatably to the radial flange 5, is accommodated in the receiving space 80. To receive two spring systems 14, the cylinder receptacle has a radially outer, essentially ring-shaped receiving shell 62 and a radially inner, also essentially ring-shaped, secondary receiving shell 70. As FIG. 11 shows in detail, each spring system 14 has a cylinder 12, which has a cylinder space 13 with an essentially circular cross section (FIG. 17). As FIG. 11 shows the most clearly, a control piston 17 is installed at each circumferential end of the cylinder space 13 with the freedom to move back and forth in the circumferential direction. Each of these control pistons consists of a hollow tube 78, which is provided at the end facing the reservoir space 32 with a piston plunger 25. The hollow tube 78 is designed with a predetermined curvature around the axis of rotation 99 of the torsional vibration damper 2. As a result of this curvature, each control piston 17 is able to shift position in the circumferential direction in the cylinder space 13, which is designed with the same curvature, as soon as drive side driver elements 37 provided on the radial flange 5 exert a circumferential actuating force on the control piston 17 in question. For this purpose, the drive side driver elements 37 project via first access openings 64 into the receiving shell 62. The drive side driver elements 37 actuate the control pistons 17 by exerting force on the end of the control piston 17 facing away from the piston plunger 25.

Second access openings 66 are provided in the receiving shell 62 with a radial offset from the first access openings 64. The size of these second openings in the circumferential direction is different from that of the first openings; in the present case, they are longer than the first access openings 64. Thus the circumferential ends 153, 154 of the two access openings 64, 66 lie in different circumferential areas of the receiving shell 62. The second access openings 66 accommodate drive side driver elements 49, which are provided on the driver element carrier 58. Because of the circumferential play which the driver elements 37, 49 have with respect to the circumferential ends 153, 154 of their assigned access openings 64, 66, the extent to which the drive side cylinder receptacle 15 and thus the drive side transmission element 88 can deflect rotationally with respect to the takeoff side driver element carrier 58 and thus the takeoff side transmission element 92 is predefined, so that the circumferential ends 154, 154 of the access openings 64, 66 act as stops between the transmission elements 88, 92.

Adjacent to the piston plunger 25 of the individual control piston 17 is a viscous medium-filled sealing chamber 61 and a secondary separating piston 48. The end of this separating piston which faces away from the sealing chamber 61 forms a boundary of a main reservoir space section 59—common to both control pistons 17—of a reservoir space 32. This main reservoir space section 59 is connected to a secondary reservoir space section 60 by a control space passage 35; the secondary reservoir space section is present jointly with a separating piston 30 and a pressure space 27 inside the secondary receiving shell 70. As previously described, the separating piston 30 serves to isolate the viscous medium-filled pressure space 27 from the gas-filled reservoir space 32. The secondary separating piston 48 performs the same task. The sealing chamber 62 supplies the viscous medium which supports the sealing of the reservoir space 32 off against the environment of the torsional vibration damper 2 and which is also available as a lubricant for the secondary separating piston 48 and especially for the associated control piston 17.

As FIGS. 16 and 17 show in detail, a fluid line 38 is connected to a pressure space 27 of the cylinder receptacle 15, and a fluid line 39 is connected to the other pressure space 27 of the cylinder receptacle 15. These two fluid lines 38, 39, serve as a feed line 34 and are connected at the end facing away from the pressure space 27 to the second pressure circuit component 109, which serves as a distributor for the fluid medium. This second component has radial passages 112, which lead to an integrated pressure line 108 in the pressure guide element 85, the pressure guide element 85 being formed here by the takeoff 86. The second pressure circuit component 109 and the pressure guide element 85 form the second rotary lead-through 114. Although the first rotary lead-through is not shown here, it is intended to be identical to the first rotary lead-through 98 discussed on the basis of FIGS. 4 and 8 in terms of its spatial arrangement with respect to the torsional vibration damper 2 and with respect to the connection to the external pressure circuit component 121 of the pressure circuit 120.

In this embodiment of the spring system 14, one of the control pistons 17 of each cylinder 12 is actuated by the drive side driver elements 37 during pull-mode operation, whereas the other control piston 17 of this cylinder 12 is actuated during push-mode operation.

In the case of torsional vibrations during pull-mode operation, the drive side transmission element 88 and thus the corresponding control piston 17, such as, for example, the control piston 17 at the top of the cylinder 12 shown on the right in FIG. 11, is pushed deeper into the cylinder space 13 by the drive side driver elements 37 and thus compresses the gaseous medium present in the reservoir space 32 until equilibrium is reached between the introduced torque and the pressure in the reservoir space 32. Conversely, in the case of torsional vibrations during push-mode operation, the takeoff side transmission element 92 and thus the corresponding control piston 17, i.e., the control piston shown at the bottom of the cylinder 12 on the right in FIG. 11, is pushed deeper into the cylinder space 13 by the takeoff side driver elements 49 and thus compresses the gaseous medium present in the reservoir space 32 until an equilibrium is reached between the introduced torque and the pressure in the reservoir space 32.

Because the cylinder 12 of the cylinder receptacle 15 on the left in FIG. 11 acts in a manner comparable to that of the previously described cylinder 12, there is no need to explain this again.

To increase the pressure in the pressure space 27, viscous medium is supplied to the pressure space 27 via the first rotary lead-through (not shown) and via the second rotary lead-through 114; to lower the pressure, the medium is withdrawn. Thus, in this embodiment of the torsional vibration damper 2, the feed line 34, in conjunction with the pressure circuit 120 shown in FIG. 8, takes over the function of the pressure-setting device 127. By increasing the pressure in the pressure space 27 and thus in the reservoir space 32, the effect of a higher spring pretension and of a higher spring stiffness is obtained; conversely, by lowering the pressure in the pressure space, the effect of a lower spring pretension and of a lower spring stiffness is obtained. In this way, as seen in FIG. 9, the characteristic of the spring system 14 is adapted to the assigned value of the torque to be transmitted. As a result of this adaptation, a characteristic which is optimally adapted to the load state present at the moment in question is always obtained, so that, in practice, the entire spring travel of which the spring system 14 is capable in the presence of this characteristic is available for the damping of any torsional vibrations which may be caused by alternating loads. Of course, a further increase in the load can be compensated by an even higher pressure in the pressure space 27 and therefore in the reservoir space 32 and thus an even higher characteristic can be realized, whereas a decrease in the load can be compensated by lowering the pressure in the pressure space 27 and therefore in the reservoir space 32, which leads to the realization of a lower characteristic. Here, too, the transition between the individual characteristics can occur in large, predefined steps or in a manner which is at least essentially continuous.

FIGS. 12 and 13 show another embodiment of the torsional vibration damper 2. Because, in comparison with the embodiment according to FIGS. 10 and 11, one of the control pistons 17 and the associated secondary separating piston 48 have been eliminated from each cylinder 12, it is necessary, if the same functionality is to be achieved, for the cylinders 12 to have freedom of relative movement with respect to the piston receptacle 15 and thus with respect to the transmission element which holds this piston receptacle 15 nonrotatably, in the present case the drive side transmission element 88. For this purpose, the cylinder 12 in question is mounted in a carrier device 82, which is centered and axially positioned on a support ring 156 of the drive side transmission element 88 by means of a bearing 155, in the present case a roller bearing (FIG. 13), the support ring being connected nonrotatably to the radial flange 5. At the same time, this carrier device is capable of relative rotation around the axis of rotation 99. Relative rotatability is also present with respect to the takeoff side transmission element 92, where the takeoff side transmission element 92 is mounted rotatably on the primary hub 7 of the drive side transmission element 88 by means of a secondary hub 8.

Bent sections 157, 158 are provided both on the radial flange 5 and also on the cover element 73 connected nonrotatably to it. These bent sections serve as drive side driver elements 37, and their free ends project through openings 93 in the carrier device 82 in order to actuate the adjacent control piston 17, thus shifting this piston deeper into the cylinder space 13 during, for example, pull-mode operation. For deflections of the spring system 14 in the opposite direction of rotation, that is, during push-mode operation, the entire cylinder 12 is shifted, namely, via the takeoff side driver element 49, which acts on a centering segment 94 of the cylinder 12 in question. The reliability with which the individual driver element 37, 49 will engage can be improved by designing it to cooperate with an assigned groove, where a first groove 95 is assigned to the drive side driver element 37 and a second groove 96 is assigned to the takeoff side driver element 45.

FIGS. 14 and 15 show again an embodiment of the torsional vibration damper 2 in which the cylinder receptacle 15 forms a nonrotatable component of the drive side transmission element 88. The cylinder receptacle 15 has a receiving shell 62 and a secondary receiving shell 70, where the two receiving shells 62 and 70 are arranged radially with respect to each other. Whereas the secondary receiving shell 70 holds a control piston 17 at each circumferential end of its cylindrical space 13 and serves as a main pressure space section 28 of the pressure space 27, the secondary pressure space section 29 of the pressure space 27 and a separating piston 30 are accommodated in the receiving shell 62. In this embodiment, therefore, the spring system 14 is actuated exclusively by hydraulic means, and each of the two cylinders 12 of the cylinder receptacle 15 acts in only one direction of rotation, that is, either for operation in pull mode or for operation in push mode.

### LIST OF REFERENCE NUMBERS

1 drive
2 torsional vibration damper
3 crankshaft
4 connecting elements
5 radial flange
6 openings
7 primary hub
8 secondary hub
9 gear ring
12 cylinder
13 cylinder space
14 spring system
15 cylinder receptacle
17 control piston
18 fluid holding chamber
20 fluid displacer
21 axial shoulder
22 seal
23 fluid displacement element
24 fluid baffle element
25 piston plunger
27 pressure space
28 main pressure space section
29 secondary pressure space section
30 separating piston
31 damping device
32 reservoir space
33 reservoir space connection
34 feed line
35 reservoir passages
36 partition wall
37 drive side driver element
38 fluid line
39 fluid line
42 circumferential ring
44 closing cover
46 support ring
48 secondary separating piston
49 takeoff side driver element
50 flow channel
51 flow channel
54 bearing
56 takeoff side flywheel mass
57 friction surface
58 driver element carrier
59 main reservoir space section
60 secondary reservoir space section
61 sealing chamber
62 receiving shell
64 first access openings
66 second access openings
68 pressure space passage
70 secondary receiving shell
72 pressure space connection
73 cover element
74 axial energy storage device
75 support surface
76 rotational angle limiter
78 hollow tube
80 receiving space
82 carrier device
84 gearbox input shaft
85 pressure guide element
86 takeoff
88 drive side transmission element
92 takeoff side transmission element
93 access openings
94 centering segment
94 first groove
96 second groove
98 first rotary lead-through
99 axis of rotation
100 feed line
101 first pressure circuit component
102 fluid line
103 fluid line
106 radial passage
108 integrated pressure line
109 second pressure circuit component
112 radial passage
114 second rotary lead-through
120 pressure circuit
121 external pressure circuit section
122 first correcting element group
123 second correcting element group
124 third correcting element group
125 fourth correcting element group
127 pressure-setting device
129 closed-loop and/or open-loop control device
132 low-pressure reservoir
136 supply reservoir
138 pump
139 pump drive
142, 143 correcting element
144, 145 correcting element
146, 147 correcting element
148, 149 correcting element
150 sensor
152 pressure source
153 circumferential end
154 circumferential end
155 bearing
156 inertia ring
157 bent section
158 bent section

1-58. (canceled)

59. A torsional vibration damper for installation between a rotating drive and a rotating takeoff, the damper comprising:
a drive side transmission element which can be connected to the drive;
a takeoff side transmission element which can be connected to the takeoff;
a damping device installed between the transmission elements, the damping device comprising a spring system which transmits torque between the drive side transmission element and the takeoff side transmission element, the spring system comprising at least one reservoir space containing a gaseous medium, whereby the spring system has a spring characteristic which is pressure-dependent;
at least one pressure space filled with a hydraulic medium in working connection with a respective said at least one reservoir space; and
a pressure circuit which can adjust the pressure in each said pressure space in response to changes in torque transmitted by the damping device, whereby the spring characteristic can be adjusted as the torque changes.

60. The torsional vibration damper of claim 59 wherein said at least one pressure space is contained in at least one of said transmission elements, said pressure circuit comprising an external pressure circuit section located outside of said transmission elements.

61. The torsional vibration damper of claim 60 further comprising at least one rotary lead-through connecting the external pressure circuit section to the at least one pressure space.

62. The torsional vibration damper of claim 61 wherein the external pressure circuit comprises a pump, the damper comprising
a first rotary lead-through connected to the pump by at least one first hydraulic feed line;
a second rotary lead-through connected to the at least one pressure space by at least one second hydraulic feed line; and
a pressure guide element connecting the first and second rotary lead-throughs.

63. The torsional vibration damper of claim 62 wherein the number of first hydraulic feed lines and the number of second hydraulic feed lines corresponds to the number of pressure spaces.

64. The torsional vibration damper of claim 59 further comprising a separating piston between each said pressure space and the respective said reservoir space.

65. The torsional vibration damper of claim 64 wherein the spring system comprises a cylinder space in which each said separating piston can move back and forth, and a seal surrounding each said separating piston.

66. The torsional vibration damper of claim 65 wherein the cylinder space is ring-shaped.

67. The torsional vibration damper of claim 65 wherein the cylinder space is accommodated in said drive-side transmission element.

68. The torsional vibration damper of claim 59 wherein the damping device comprises two spring systems which act in opposition to each other, each spring system comprising a cylinder having a separating piston between a reservoir space containing a gaseous medium and a pressure space containing hydraulic fluid.

69. The torsional vibration damper of claim 68 wherein each said pressure space comprises a main pressure space section and a secondary pressure space section connected by a reservoir space passage, wherein the secondary pressure space section is adjacent to the separating piston.

70. The torsional vibration damper of claim 69 wherein the main pressure space section is bounded by a fluid holding chamber and a fluid displacer, wherein the fluid displacer has at least one fluid displacement element extending toward the fluid holding chamber, and the fluid holding chamber has at least one fluid baffle element extending toward the fluid displacer, whereby rotation of the displacer relative to the fluid holding chamber can adjust the pressure in the pressure space.

71. The torsional vibration damper of claim 70 further comprising a cylinder receptacle fixed non-rotatably to one of said transmission elements, said cylinder being fixed in said cylinder receptacle, said fluid holding chamber being fixed non-rotatably to said one said transmission elements radially adjacent to said cylinder receptacle, said fluid displacer being fixed nonrotatably to the other of said transmission elements.

72. The torsional vibration damper of claim 71 wherein the cylinder receptacle and the fluid holding chamber are fixed to the drive side transmission element, and the fluid displacer is fixed to the takeoff side transmission element.

73. The torsional vibration damper of claim 70 wherein the external pressure circuit comprises a pump, the damper comprising
a first rotary lead-through connected to the pump by at least one first hydraulic feed line;
a second rotary lead-through connected to the at least one pressure space by at least one second hydraulic feed line; and
a pressure guide element connecting the first and second rotary lead-throughs,
wherein the at least one second hydraulic feed line is mounted on the fluid displacer and secured thereto by a respective at least one pressure space connection.

74. The torsional vibration damper of claim 70 wherein the fluid holding chamber is fixed directly to the drive, the damper further comprising a bearing by which the fluid displacer is centered and axially secured.

75. The torsional vibration damper of claim 59 wherein the damping device comprises two spring systems which act in opposition to each other, the pressure circuit comprising a pump having a discharge side and a suction side, a first correcting element group connecting the pump to the pressure space of one of said spring systems so that the pressure therein can be increased, and a second correcting element group connecting the pump to the pressure space of the other of said spring systems so that the pressure therein can be increased.

76. The torsional vibration damper of claim 73 further wherein the first and second correcting element groups are connected to the discharge side of the pump via a supply reservoir.

77. The torsional vibration damper of claim 73 further comprising a third correcting element group connecting the pump to the pressure space of said one of said spring systems so that the pressure therein can be decreased, and a fourth correcting element group connecting the pump to the pressure space of the other of said spring systems so that the pressure therein can be decreased.

78. The torsional vibration damper of claim 77 further wherein the third and fourth correcting element groups are connected to the suction side of the pump via a low-pressure supply reservoir.

79. The torsional vibration damper of claim 75 wherein the pump has two suction sides, the damper further comprising a hydraulic medium reservoir connected to one of said suction sides.

80. The torsional vibration damper of claim 77 further comprising a control device connected to a drive of the pump and at least one correcting element of the correcting element groups for adjusting a working position of the at least one correcting element by at least one of open-loop and closed-loop control.

81. The torsional vibration damper of claim 80 wherein the main pressure space section is bounded by a fluid holding chamber and a fluid displacer, the damper further comprising a sensor which senses the position of the fluid displacer, the sensor being connected to the control device.

82. The torsional vibration damper of claim 59 wherein the damping device comprises two spring systems which act in opposition to each other, each said spring system having a control piston, wherein the drive side transmission element has at least one drive side driver element engaging between the two control pistons, and the takeoff side transmission element has at least one takeoff-side driver element engaging between the two control pistons, wherein the driver elements can be brought into working connection with the control pistons independently of each other.

83. The torsional vibration damper of claim 82 wherein
the pressure space is separated from the reservoir space by a primary separating piston; and
each said spring system comprises a cylinder having a cylinder space containing a respective said control piston, a sealing chamber filled with hydraulic medium, and a secondary separating piston between the sealing chamber and the reservoir space.

84. The torsional vibration damper of claim 82 further comprising a first ring-shaped receiving shell in said one of said transmission elements, said cylinders being accommodated in said ring-shaped receiving shell.

85. The torsional vibration damper of claim 84 wherein said ring-shaped receiving shell has at least one first access opening for the at least one drive side driver element, and at least one second access opening for the at least one takeoff-side driver element.

86. The torsional vibration damper of claim 85 further comprising rotational angle limiters for limiting the circumferential travel of the driver elements with respect to the receiving shell.

87. The torsional vibration damper of claim 84 further comprising a second ring-shaped receiving shell which cooperates with said first ring-shaped receiving shell to form said reservoir space, said reservoir space comprising a main reservoir space section in said first ring-shaped receiving shell and a secondary reservoir space section in said second ring-shaped receiving shell, wherein said main reservoir space section and said secondary reservoir space section are connected by at least one reservoir passage.

88. The torsional vibration damper of claim 87 further comprising individual pressure space connections mounted and secured against movement on one of the first and second ring-shaped receiving shells.

89. The torsional vibration damper of claim 87 wherein at least one of said first and second ring-shaped receiving shells is fixed non-rotatably to the drive side transmission element, the damper further comprising a driver element carrier which carries the takeoff side driver element, and a bearing which centers the driver element carrier with respect to the drive side transmission element.

90. The torsional vibration damper of claim 89 further comprising a flywheel fixed to the driver element carrier.

91. The torsional vibration damper of claim 90 further comprising a cover installed axially between the driver element carrier and the flywheel, the cover and the flywheel each having a support surface for an axial energy storage device.

92. The torsional vibration damper of claim 83 wherein each said cylinder space contains two control pistons acting in opposite directions to form a double acting cylinder with a common said pressure space.

93. The torsional vibration damper of claim 92 wherein each said cylinder space further contains a separating piston assigned to each said control piston, and a sealing chamber located between each said separating piston and the respective said control piston.

94. The torsional vibration damper of claim 92 wherein each said control piston comprises a hollow tube which has a predetermined curvature around an axis of rotation of the transmission elements, and a piston plunger closing off one end of the tube.

95. The torsional vibration damper of claim 83 further comprising a carrier device which is centered with respect to the transmission elements and can rotate relative to the transmission elements, said cylinders being mounted with freedom of axial movement in the carrier device, the carrier device having access openings for the driver elements of at least one of the transmission elements.

96. The torsional vibration damper of claim 95 further comprising centering segments which position respective said cylinders radially and axially.

97. The torsional vibration damper of claim 96 wherein at least one of the centering segments and the control pistons is provided with a groove which is engaged by the driver elements.

98. The torsional vibration damper of claim 68 wherein each said pressure space comprises a main pressure space section and a secondary pressure space section connected by a pressure space passage, the main pressure space section having a control piston at each circumferential end, the secondary pressure space section being in working connection with the reservoir space by way of a sealing chamber and the separating piston.

99. The torsional vibration damper of claim 98 wherein the external pressure circuit comprises a pump, the damper comprising
a first rotary lead-through connected to the pump by at least one first hydraulic feed line;
a second rotary lead-through connected to the at least one pressure space by at least one second hydraulic feed line;
a pressure guide element connecting the first and second rotary lead-throughs;
pressure space connections adjacent to at least one of the control pistons; and
fluid lines leading from the pressure guide element via the second rotary lead-through into the main pressure space section, wherein the fluid lines are secured against movement in the pressure space connections.
